(19) United States
(12) Patent Application Publication
(10) Pub. No.: US 2012/0331512 A1
(43) Pub. Date: Dec. 27, 2012

(54) AV CONTENTS VIEWING AND LISTENING SYSTEM PROVIDED IN CABIN OF PASSENGER CARRIER

(76) Inventor: Ryo KURITA, Osaka (JP)

(21) Appl. No.: 13/529,112

(22) Filed: Jun. 21, 2012

(30) Foreign Application Priority Data
Jun. 22, 2011 (JP) 2011-137974
Jun. 15, 2012 (JP) 2012-136003

(51) Int. Cl. H04N 21/214

(52) U.S. Cl. 725/77

(57) ABSTRACT

An AV contents viewing and listening system includes a seat terminal apparatus, a compact terminal apparatus, and a display terminal apparatus. The seat terminal apparatus is connected to an AV server that stores AV contents to be distributed including video data and audio data via a transmission path, receives and outputs at least the audio data. A compact terminal apparatus is connected to the seat terminal apparatus via a terminal apparatus transmission path, and receives and displays at least the video data, and a display terminal apparatus receives the video data from the compact terminal apparatus and display the data. The video data is displayed one of by selective changeover between the compact terminal apparatus and the display terminal apparatus, and by simultaneously display on both of the compact terminal apparatus and the display terminal apparatus.

### BACKGROUND OF THE INVENTION

1. Field of the Invention

The present invention relates to an AV contents viewing and listening system, which is mounted and equipped on respective seats installed in a cabin of a passenger carrier such as an aircraft, and which is provided for viewing and listening AV (audio-visual) software of movies, musics and the like and game software.

2. Description of the Related Art

Recently, in a passenger carrier such as aircraft, various in-flight services are offered for passengers by an in-flight entertainment system called IFE (In-Flight Entertainment) mounted and equipped in the aircraft or the cabin. In-flight services include, for example, allowing the passengers to view the distributed movies and listen to musics and the like by using the video display part of an LCD display apparatus provided at the seat back (backrest) of each seat and a headphone distributed in the aircraft, to play games likewise by using an operating terminal apparatus called a handset or the like provided at the armrest part of each seat, to make a phone call to the outside of the aircraft, and to use a system capable of receiving the Internet connection service (See, for example, the Patent Documents 1 and 2). These services are transmitted in a form of digital data from the AV server provided in the aircraft to the seat terminal apparatus provided at each seat through a network transmission path.

A conventional AV contents viewing and listening system 800 in an aircraft is described below with reference to FIG. 17. FIG. 17 is a block diagram and an external perspective view showing an overall configuration of the prior art AV contents viewing and listening system 800.

In the AV contents viewing and listening system 800 shown in FIG. 17, a network transmission path 2 (hereinafter, referred to as a “transmission path”) is laid along a plurality of seats 1m and 1n, and the transmission path 2 is connected to an AV server 3. The AV server 3 provides AV contents configured to include video data of movies, games and the like, and audio data. Further, flight information and so on concerning the onboard aircraft can be also provided at need.

The transmission path 2 is configured to include Ethernet (registered trademark) cables, and the transmission path 2 is connected to seat terminal apparatuses 14m and 14n every seat. Moreover, video display parts 6m and 6n of LCD displays or the like are provided at the seat back of each seat, and controllers 15m and 15n and headphones 7m and 7n are connected to the respective seats.

These apparatuses are connected to the AV server 3 permitting communications via the seat terminal apparatuses 14m and 14n. Moreover, in a crew's room 8, a microphone 8a is connected to the transmission path 2 via an IP (Internet Protocol) adapter 8b for converting an analog audio signal into digital audio packets and connecting the same to the Ethernet (registered trademark). An apparatus similar to the microphone 8a is also installed in the cockpit (not shown), and a cabin attendant and the captain make in-flight announcement and the like by using the respective microphones for the passengers.

With the above configuration, for example, when a passenger who sits on the self-seat 1m selects a movie that the passenger wants to view by operating a controller 15m, the video and audio of the movie are downloaded from the AV server 3 to the seat terminal apparatus 14n of the front seat in of the passenger and stored (it is sometimes the case where AV data including a plurality of AV contents have been preparatorily stored in the seat terminal apparatus).

The video of the movie that the passenger has selected is displayed on the video display part 6n of the front seat 1n, while the audio is transmitted from the seat terminal apparatus 14n to the hindward seat terminal apparatus 14m via the transmission path 2 in the form of digital data (audio packets) and thereafter, is demodulated in the seat terminal apparatus 14m to be restored into the original analog audio signal. The passenger can listen to the analog audio by the headphone 7m.

The in-flight announcement from the cabin attendant or the captain can be also listened to by the headphone 7m via the seat terminal apparatus 14m of the self-seat 1m. The in-flight announcement can be also heard from a loudspeaker (not shown) provided at the ceiling, whereas the passenger who is using the headphone 7m for the viewing and listening of the movie or the like cannot catch the announcement from the loudspeaker. Therefore, the in-flight announcement is transmitted to the seat terminal apparatus 14m via the transmission path 2, and thereafter, the audio of the movie is automatically switched to the audio of the announcement to allow the announcement to be listened to by the headphone 7m.

On the other hand, portable terminal apparatuses capable of enjoying outdoor video and audio are becoming popular in recent years. A technique to view and listen to the AV contents, which have been viewed and listened to by the portable terminal apparatuses, on a large display apparatus by linking such a portable terminal apparatus with the large display apparatus such as a television receiver has been proposed (See, for example, the Patent Documents 3 and 4). When offering such a service of changeover between the apparatuses for viewing and listening in an aircraft, it can be considered to make the controllers 15m and 15n have the viewing and listening function of the seat terminal apparatuses 14m and 14n. For example, in a manner similar to that of the seat terminal apparatus 14m, the controller 15m receives video data and audio data of a movie or the like from the AV server 3 through the transmission path 2, the video data is displayed on a compact display (not shown) mounted on the controller 15m, and the audio data is transmitted from the controller 15m to the hindward seat terminal apparatus 14m and is outputted to the headphone 7m.

When changing the apparatus for viewing and listening, changeover is effected by receiving the movie that the controller 15m has received and displayed on the compact display by the frontward seat terminal apparatus 14n by operating the controller 15m to display video data on the video display part 6n. By transferring audio data from the seat terminal apparatus 14n to the seat terminal apparatus 14m and outputting the data to the headphone 7m via the seat terminal apparatus 14m, the service can be offered for the passenger who sits on the self-seat 1m.

Prior Art Documents related to the present invention are as follows:
Patent Document 1: Japanese patent laid-open publication No. JP 07-143083 A;
Patent Document 2: Japanese patent laid-open publication No. JP 2006-246297 A;
Patent Document 3: Japanese patent laid-open publication No. JP 2009-130876 A; and
Patent Document 4: Japanese patent laid-open publication No. JP 2010-074579 A.

However, in such an AV contents viewing and listening system in aircraft, the audio outputted from the headphone 7m of the hindward seat terminal apparatus 14m is disadvantageously interrupted or fluctuated while the apparatus for viewing and listening is changed from the controller 15m to the seat terminal apparatus 14n, and this leads to giving an unpleasant sensation to the passenger who is viewing the video and listening to the audio. The video display is also interrupted or fluctuated, whereas the passenger feels almost no sense of incompatibility in this case since the visual point is also moved between the compact display and the video display part.

### SUMMARY OF THE INVENTION

An object of the present invention is to solve the aforementioned problems and provide an AV contents viewing and listening system capable of allowing the AV contents to be viewed and listened by a plurality of viewing and listening apparatuses in a passenger carrier such as an aircraft, and effecting changeover between the apparatuses for viewing and listening without giving any unpleasant sensation due to the interruption and fluctuation of audio to the passenger.

In order to achieve the aforementioned objective, according to one aspect of the present invention, there is provided an AV contents viewing and listening system configured to include a seat terminal apparatus, a compact terminal apparatus, and a display terminal apparatus. The seat terminal apparatus is operatively connected to an AV server that stores AV contents to be distributed including video data and audio data via a transmission path, and the seat terminal apparatus receives and outputs at least the audio data. The compact terminal apparatus is connected to the seat terminal apparatus via a terminal apparatus transmission path, and the compact terminal apparatus receives and displays at least the video data. The display terminal apparatus is configured to receive the video data from the compact terminal apparatus and display the data. The video data is displayed one of by selective changeover between the compact terminal apparatus and the display terminal apparatus, and by simultaneously display on both of the compact terminal apparatus and the display terminal apparatus.

In the above-mentioned AV contents viewing and listening system, the seat terminal apparatus is installed at each of a plurality of seats arranged frontward and hindward, and the seat terminal apparatus installed at a self-seat is a seat terminal apparatus that receives at least the audio data and outputs the data. The seat terminal apparatus installed on a back part of the front seat of the self-seat is a display terminal apparatus that is connected to a video display part, receives the video data from the compact terminal apparatus, and displays the data.

In addition, in the above-mentioned AV contents viewing and listening system, the compact terminal apparatus is configured to include a compact video display part, and a video and audio storage part that stores the AV contents distributed from the AV server. The AV contents read from the video and audio storage part are separated into video data and audio data. The separated video data is displayed on the compact video display part; otherwise the separated video data is transmitted via the terminal apparatus transmission path of the seat terminal apparatus of the self-seat, and then is displayed on the video display part connected to the seat terminal apparatus of the self-seat.

Further, in above-mentioned AV contents viewing and listening system, the compact terminal apparatus is configured to include a compact video display part, and a video and audio storage part that stores the AV contents distributed from the AV server. The AV contents read from the video and audio storage part are separated into video data and audio data. The separated video data is displayed on the compact video display part; otherwise the separated video data is transmitted via the terminal apparatus transmission path of the seat terminal apparatus of the self-seat, and then is displayed on the video display part connected to the seat terminal apparatus of the front seat.

Furthermore, in the above-mentioned AV contents viewing and listening system, the seat terminal apparatus is configured to include a video and audio storage part that stores the AV contents distributed from the AV server. The AV contents read from the video and audio storage part are separated into video data and audio data. The separated audio data is outputted from the seat terminal apparatus of the self-seat. The separated video data is displayed on the video display part connected to the seat terminal apparatus of the self-seat; otherwise the separated video data is transmitted via the terminal apparatus transmission path of the seat terminal apparatus of the self-seat, and then is displayed on the compact video display part of the compact terminal apparatus.

Still further, in the above-mentioned AV contents viewing and listening system, the seat terminal apparatus includes a video and audio storage part that stores the AV contents distributed from the AV server. The AV contents read from the video and audio storage part are separated into video data and audio data. The separated audio data is outputted from the seat terminal apparatus of the self-seat. The separated video data is transmitted via the terminal apparatus transmission path of the seat terminal apparatus of the self-seat, and then is displayed on the compact video display part of the compact terminal apparatus; otherwise the separated video data is displayed on the video display part connected to the seat terminal apparatus of the front seat.

Still more further, in the above-mentioned AV contents viewing and listening system, the compact terminal apparatus is a compact video controller provided for operations of selecting predetermined AV contents and instructing the AV server to distribute the AV contents.

Further, in the above-mentioned AV contents viewing and listening system, the AV contents distributed from the AV server is encoded compressed data. The AV contents is stored in a video and audio storage part of one of the compact terminal apparatus and the seat terminal apparatus, and the AV contents are decoded and outputted by a decoder provided in one of the compact terminal apparatus and the seat terminal apparatus.

Furthermore, in the above-mentioned AV contents viewing and listening system, the audio data is outputted by a headphone connected to the seat terminal apparatus of the self-seat.

Still further, in the above-mentioned AV contents viewing and listening system, a display timing of the video data and an output timing of the audio data are adjusted so that one of the video displayed on the compact video display part and the video displayed on the video display part is synchronized with an audio outputted by the headphone.

Still more further, in the above-mentioned AV contents viewing and listening system, the AV contents viewing and listening system is mounted in an aircraft.

According to the present invention, the AV contents viewing and listening system can be provided, which is capable of allowing the AV contents to be viewed and listened by the plurality of viewing and listening apparatuses in a passenger carrier such as aircraft, and effecting changeover between the apparatuses for viewing and listening without giving any unpleasant sensation due to the interruption and fluctuation of audio to the passenger.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram and an external perspective view showing an overall configuration of an AV contents viewing and listening system 100 according to a first preferred embodiment of the present invention;

FIG. 2 is a block diagram showing detailed configurations of the seat terminal apparatuses 4m and 4n and the compact video controller 5m of FIG. 1;

FIG. 3 is an external perspective view showing details of the seats 1m and 1n and the peripheral apparatuses of FIG. 1;

FIG. 4 is a timing chart showing operations of the AV contents viewing and listening system 100 of FIG. 1;

FIG. 5 is a block diagram and an external perspective view showing an overall configuration of an AV contents viewing and listening system 200 according to a second preferred embodiment of the present invention;

FIG. 6 is a block diagram showing detailed configurations of the seat terminal apparatuses 4m and 4n and the compact video controller 5m of FIG. 4;

FIG. 7 is a timing chart showing operations of the AV contents viewing and listening system 200 of FIG. 4;

FIG. 8 is a block diagram and an external perspective view showing an overall configuration of an AV contents viewing and listening system 300 according to a third preferred embodiment of the present invention;

FIG. 9 is a block diagram showing detailed configurations of the seat terminal apparatuses 4m and 4n and the compact video controller 5m of FIG. 8;

FIG. 10 is a timing chart showing operations of the AV contents viewing and listening system 300 of FIG. 8;

FIG. 11 is a block diagram and an external perspective view showing an overall configuration of an AV contents viewing and listening system 400 according to a fourth preferred embodiment of the present invention;

FIG. 12 is a block diagram showing detailed configurations of the seat terminal apparatuses 4m and 4n and the compact video controller 5m of FIG. 11;

FIG. 13 is a timing chart showing operations of the AV contents viewing and listening system 400 of FIG. 11;

FIG. 14 is a block diagram and an external perspective view showing an overall configuration of an AV contents viewing and listening system 500 according to a fifth preferred embodiment of the present invention;

FIG. 15 is a block diagram and an external perspective view showing an overall configuration of an AV contents viewing and listening system 600 according to a sixth preferred embodiment of the present invention;

FIG. 16 is a block diagram and an external perspective view showing an overall configuration of an AV contents viewing and listening system 700 according to a seventh preferred embodiment of the present invention; and

FIG. 17 is a block diagram and an external perspective view showing an overall configuration of a prior art AV contents viewing and listening system 800.

### DETAILED DESCRIPTION OF THE PREFERRED EMBODIMENTS

Preferred embodiments of the present invention will be described in detail below with reference to the drawings. In the drawings, like components are denoted by like reference-numerals.

### First Preferred Embodiment

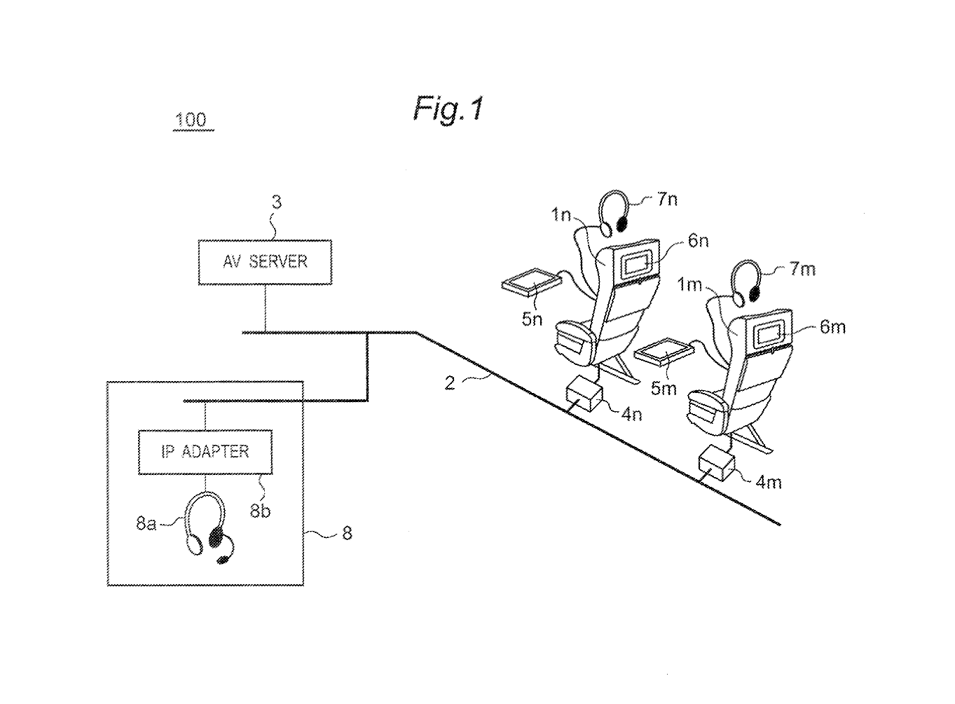

An AV contents viewing and listening system 100 according to the first preferred embodiment of the present invention is described below with reference to FIGS. 1 to 4.

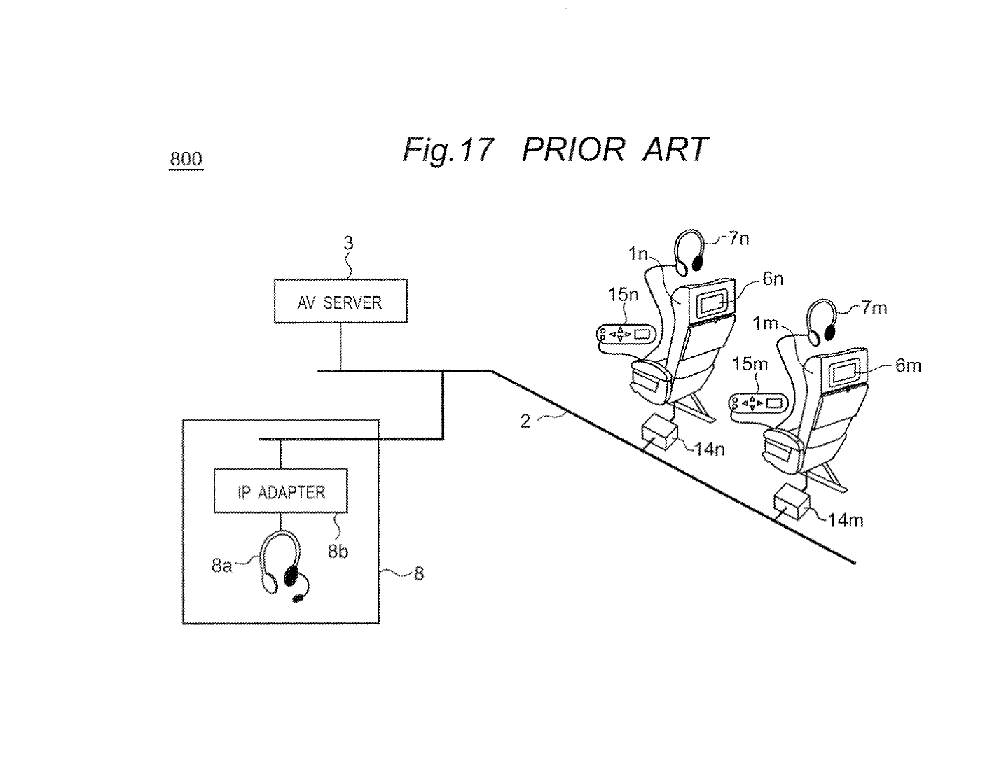

FIG. 1 is a block diagram and an external perspective view showing an overall configuration of the AV contents viewing and listening system 100 of the first preferred embodiment of the present invention. In comparison with the prior art AV contents viewing and listening system 800 of FIG. 17, the configuration in appearance of the AV contents viewing and listening system 100 of the present preferred embodiment of FIG. 1 is characterized in that:

(1) compact video controllers 5m and 5n are newly added in place of the controllers 15m and 15n; and

(2) seat terminal apparatuses 4m and 4n respectively having interfaces with the compact video controllers 5m and 5n are installed in place of the seat terminal apparatuses 14m and 14n.

The other parts are the same and therefore denoted by same reference numerals, and no description is provided for the parts that have already been described.

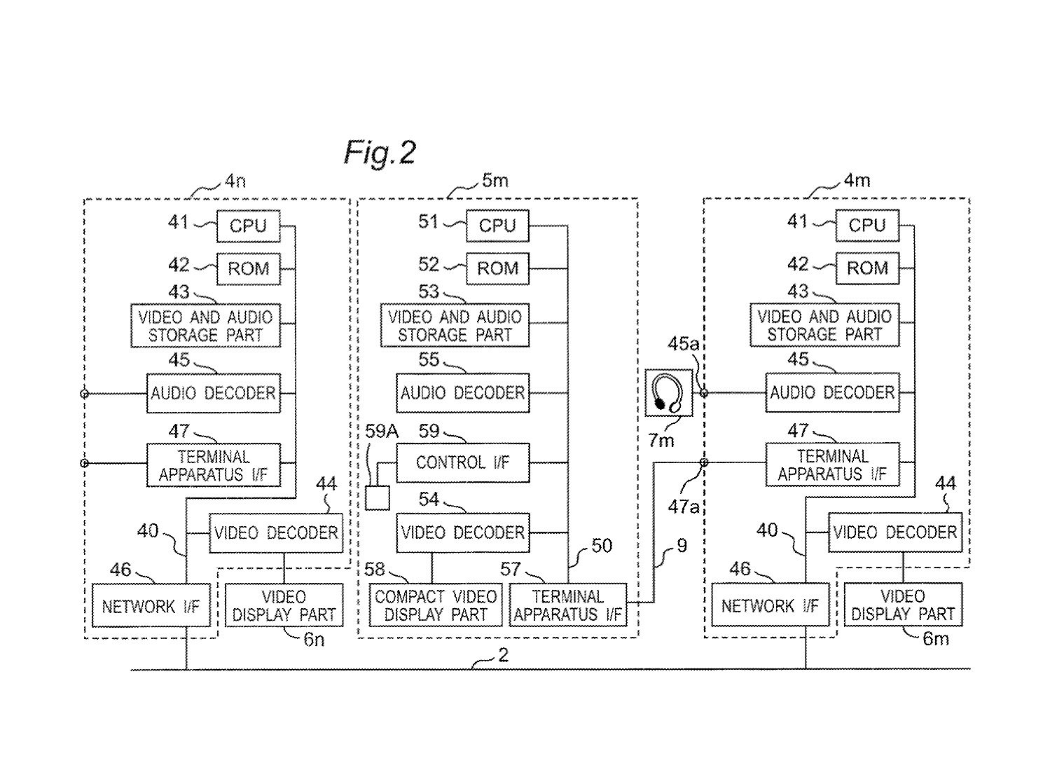

FIG. 2 is a block diagram showing detailed configurations of the seat terminal apparatuses 4m and 4n and the compact video controller 5m of FIG. 1, and

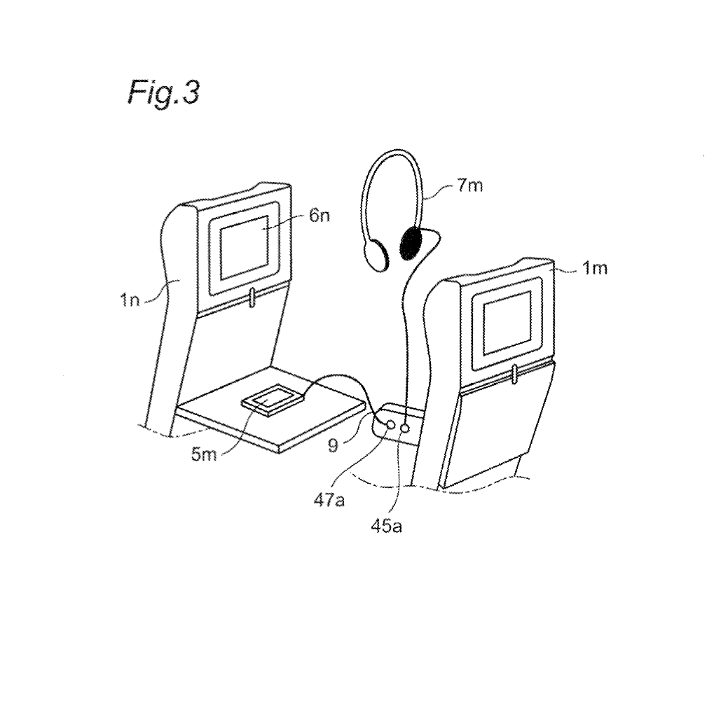

FIG. 3 is an external perspective view showing details of the seats 1m and 1n and the peripheral apparatuses of FIG. 1. Referring to FIGS. 2 and 3, the AV contents viewing and listening system 100 is configured to include the seat terminal apparatus 4m installed at the self-seat 1m, the compact video controller 5m, the seat terminal apparatus 4n installed at the front seat in, and the peripheral configuration, which have been described with reference to FIG. 1. In FIG. 2, the seat terminal apparatuses 4n (front seat 1n) and 4m (self-seat 1m), and the compact video controller 5m, which are connected to a transmission path 2 linked to the AV server 3, are indicated by respective dotted line frames in FIGS. 2 and 3.

Among these configured blocks, the seat terminal apparatus 4m is first described. The seat terminal apparatus 4m is configured to include a CPU 41, a ROM 42, a video and audio storage part 43, a video decoder 44, an audio decoder 45, a network I/F 46, and a terminal apparatus I/F 47. It is noted that the seat terminal apparatus 4n is also configured to include similar components, and no description is provided for them. The CPU 41 is the central processing unit of a microcomputer or the like to control the entire seat terminal apparatus. The seat terminal apparatus 4m is configured to include the CPU 41, and the components described below are connected to a bus 40 to mutually exchange information as shown in FIG. 2. A program of the CPU 41 is stored in the ROM 42.

The video and audio storage part 43 stores compressed video data and compressed audio data that have been compressed by MPEG (Moving Picture Experts Group) 2 or the like downloaded from the AV server 3 via the transmission path 2. The video decoder 44 and the audio decoder 45 are decoders for decoding and reproducing the compressed video data and the compressed audio data, respectively, which have been stored in the video and audio storage part 43. A video display part 6m is connected to the video decoder 44, and a headphone 7m is connected to the audio decoder 45 via a headphone terminal 45a. Although the seat terminal apparatus 4m and the video display part 6m are mutually separated in the present preferred embodiment, they may be integrated together.

Moreover, in-flight announcements of the captain and the cabin attendant to the passengers from a microphone 8a of the cockpit and the crew's room 8 are also transmitted via an IP adapter 8b and the transmission path 2, and thereafter, are taken into the seat terminal apparatus 4m and listened to by the headphone 7m. A network interface (interface is hereinafter referred to as “I/F”) 46 is an interface with the transmission path 2 and has an inherent address (MAC address etc.) for identifying the seat terminal apparatus. The terminal apparatus I/F 47 is an interface with the compact video controller 5m connected to the seat terminal apparatus 4m, and exchanges data between the seat terminal apparatus 4m and the compact video controller 5m via a controller terminal 47a and a terminal apparatus transmission path 9. The terminal apparatus transmission path 9 is configured to include an Ethernet (registered trademark) cable, a serial bus or the like.

The compact video controller 5m is described next. The compact video controller 5m is configured to include a CPU 51, a ROM 52, a video and audio storage part 53, a video decoder 54, an audio decoder 55, and a terminal apparatus I/F 57 in a manner similar to those of the seat terminal apparatuses 4m and 4n, and they are connected with each other via a bus 50. The compressed video data and the compressed audio data stored in the video and audio storage part 53 of the compact video controller 5m are distributed from the AV server 3 by way of the transmission path 2, the network I/F 46 of the seat terminal apparatus 4m, the terminal apparatus I/F 47, the controller terminal 47a, and the terminal apparatus transmission path 9 via the terminal apparatus I/F 57 and the bus 50. The video decoder 54 is connected to a built-in compact video display part 58 of the compact video controller 5m, and displays video in a manner similar to that of the video display parts 6m and 6n of the seat terminal apparatuses 4m and 4n. The control I/F 59 is an interface that receives an operation input of the passenger by an operation panel 59A. In this case, the operation panel 59A may be a touch panel operation part of the compact video display part 58.

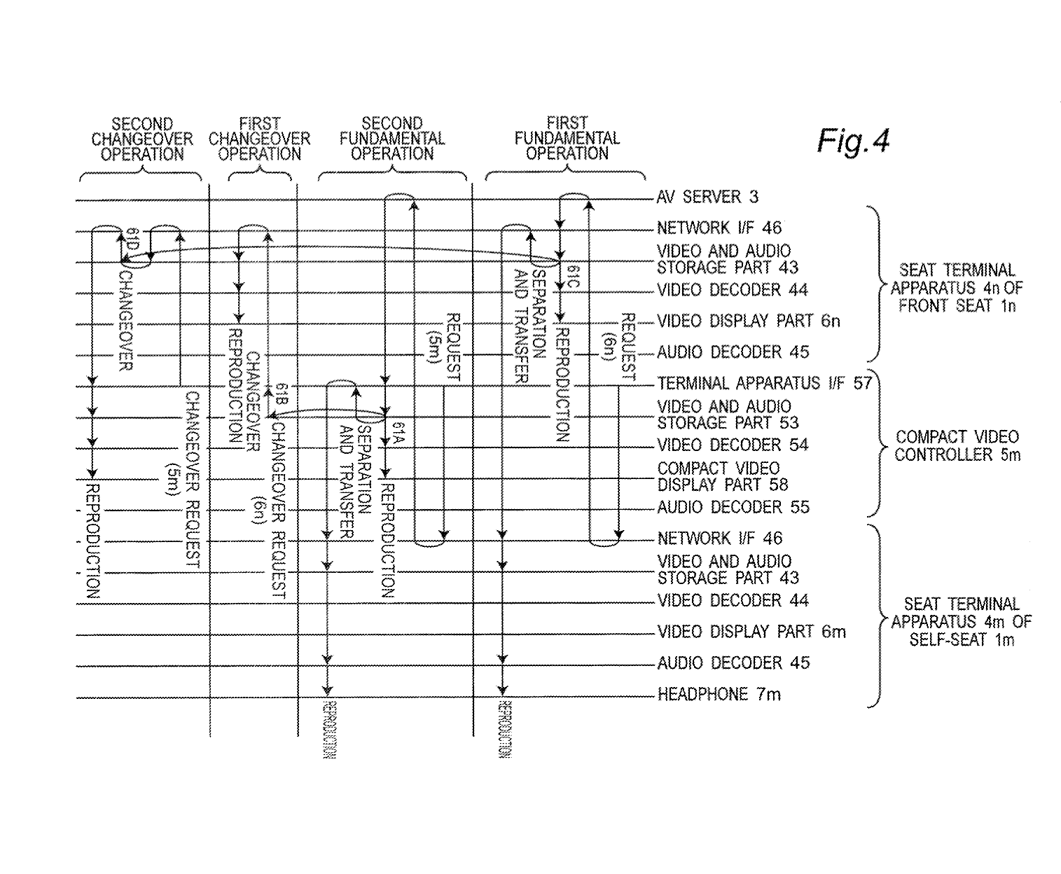

In the aforementioned configuration, operations of the AV contents viewing and listening system 100 of the present preferred embodiment is described next with reference to FIG. 4. FIG. 4 is a timing chart showing operations of the AV contents viewing and listening system 100 of FIG. 1. First of all, a case where the passenger in the self-seat 1m views and listens to the AV contents stored in the AV server 3 by the seat terminal apparatus 4n of the front seat 1n (first fundamental operation) is described with reference to FIG. 4.

In the first fundamental operation of FIG. 4, when the passenger selects viewing and listening of the AV contents that the passenger wants to view by the front seat 1n (or the video display part 6n of the front seat 1n) by operating the compact video controller 5m of the self-seat 1m, a request signal including the selected information is transmitted to the AV server 3 via the transmission path 2, the AV data configured to include the compressed video data and the compressed audio data including the AV contents are distributed from the AV server 3 to the seat terminal apparatus 4n of the front seat 1n, and are temporarily stored in the internal video and audio storage part 43. When the passenger instructs reproduction or the like by operating the compact video controller 5m, for example, the CPU executes predetermined software (or by an exclusive hardware circuit) to separate the compressed video data and the compressed audio data from the AV data stored in the video and audio storage part 53. Thereafter, the compressed video data is decoded in the video decoder 44 inside the seat terminal apparatus 4n of the front seat 1n and displayed on the video display part 6n. On the other hand, the compressed audio data is sent to the seat terminal apparatus 4m of the self-seat 1m via the network I/F 46 and the transmission path 2. At the seat terminal apparatus 4m of the self-seat 1m, the loaded compressed audio data is decoded by the audio decoder 45, and thereafter, is listened to as an audio by the headphone 7m of the self-seat 1m.

Next, a case where the passenger views and listens to the AV contents stored in the AV server 3 by the compact video controller 5m (second fundamental operation) is described with reference to FIG. 4.

In the second fundamental operation of FIG. 4, when the passenger selects viewing and listening of the AV contents that the passenger wants to view by operating the compact video controller 5m of the self-seat 1m, a request signal including the selected information is transmitted to the AV server 3 via the transmission path 2, the AV data configured to include the compressed video data and the compressed audio data including the AV contents are distributed from the AV server 3 to the compact video controller 5m via the seat terminal apparatus 4m of the self-seat 1m, and are temporarily stored in the internal video and audio storage part 53. When the passenger instructs reproduction or the like by operating the compact video controller 5m, for example, the CPU executes predetermined software (or by an exclusive hardware circuit) to separate the compressed video data and the compressed audio data from the AV data stored in the video and audio storage part 53. Thereafter, the compressed video data is decoded in the video decoder 54 inside the compact video controller 5m and displayed on the compact video display part 58. On the other hand, the compressed audio data is sent to the seat terminal apparatus 4m of the self-seat 1m via the network I/F 57 and the terminal apparatus transmission path 9. At the seat terminal apparatus 4m of the self-seat 1m, the loaded compressed audio data is decoded by the audio decoder 45, and thereafter, is listened to as an audio by the headphone 7m of the self-seat 1m in a manner similar to that of the case of the aforementioned viewing and listening by the seat terminal apparatus.

Next, a case is described where the passenger performs changeover from the viewing and listening by the compact video display part 58 of the compact video controller 5m to viewing and listening by the video display part 6n of the seat terminal apparatus 4n (first changeover operation).

In the first changeover operation of FIG. 4, when the passenger selects viewing and listening by the video display part 6n of the seat terminal apparatus 4n by operating the compact video controller 5m of the self-seat 1m in the state of viewing and listening of AV contents with the compact video display part 58 of the compact video controller 5m of the self-seat 1m (61A of FIG. 4), the compressed video data stored in the video and audio storage part 53 inside the compact video controller 5m is not delivered to the internal video decoder 54 but sent to the seat terminal apparatus 4n of the front seat 1n via the network I/F 57 and the terminal apparatus transmission path 9 and further via the network I/F 46 and the transmission path 2 of the seat terminal apparatus 4m (61B of FIG. 4). At the seat terminal apparatus 4n of the front seat 1n, the loaded compressed video data is decoded by the video decoder 44 and is displayed on the video display part 6n. On the other hand, the compressed audio data is sent from the compact video controller 5m of the self-seat 1m to the seat terminal apparatus 4m and listened to as an audio by the headphone 7m of the self-seat 1m with remaining unchanged from before the changeover between the terminal apparatuses for viewing and listening.

In this case, since the video display is delayed by the time of transmission of the compressed video data via the transmission path 2 and the terminal apparatus transmission path 9, synchronization with the video of the front seat 1n is achieved by delaying the read timing of the compressed audio data from the video and audio storage part 43 of the seat terminal apparatus 4m of the self-seat 1m by the time of transmission via the transmission path 2 regardless of the changeover of viewing and listening and also delaying the read timing of the compressed video data from the video and audio storage part 53 of the compact video controller 5 in by the time of transmission via the transmission path 2 and the terminal apparatus transmission path 9. The method of achieving the synchronization with the video of the present invention is not limited to this, and it is acceptable to add a delay circuit for simultaneously reading the video and audio compressed data and delaying the video and audio data by the time. Further, more accurate synchronization becomes possible if reproduction is made by inserting a time stamp into the video and audio data, and the amount of delay is controlled on the basis of the time stamp.

When the passenger instructs stop or temporary stop and instructs again reproduction or the like by operating the compact video controller 5m after the first changeover operation, the AV data including the AV contents that have been viewed and listened to by the compact video display part 58 of the compact video controller 5m is distributed from the AV server 3 to the seat terminal apparatus 4n of the front seat 1n and is temporarily stored in the internal video and audio storage part 43, and changeover to viewing and listening on the video display part 6n of the seat terminal apparatus 4n of the front seat 1n is subsequently effected.

As described above, in the present preferred embodiment, the compact video controller 5m is provided, and the compact video controller 5m receives the AV contents of the AV server 3, displays the video on the compact video display part 58 (61A of FIG. 4), and sends the audio to the seat terminal apparatus 4m of the self-seat 1m. The passenger listens to the audio by the headphone 7m of the self-seat 1m. When changeover of the video to viewing and listening on the video display part 6n of the seat terminal apparatus 4n is effected by the compact video controller 5m, the compact video controller 5m sends the video to the seat terminal apparatus 4n of the front seat 1n (61B of FIG. 4), displays the video on the video display part 6n of the front seat 1n, and the audio is continuously listened to by the headphone 7m of the self-seat 1m.

With the above configuration, according to the present preferred embodiment, changeover between the apparatuses for viewing and listening can be effected without giving any unpleasant sensation due to interruption or fluctuation to the passenger.

Although the changeover of viewing and listening to the seat terminal apparatus 4n from the compact video controller 5m (first changeover operation) is effected in the present preferred embodiment, the present invention is not limited to this, and it is acceptable to effect changeover of viewing and listening from the seat terminal apparatus 4n to the compact video controller 5m (second changeover operation). In the case, when the passenger selects viewing and listening by the compact video display part 58 of the compact video controller 5m by operating the compact video controller 5m of the self-seat 1m in the state of viewing and listening of AV contents with the video display part 6n of the seat terminal apparatus 4n (61C of FIG. 4) in the second changeover operation of FIG. 4 as described above, the seat terminal apparatus 4n sends the compressed video data from the internal video and audio storage part 43 to the compact video controller 5m, and the compact video controller 5m decodes the data in the internal video decoder 54 and displays the resulting data on the compact video display part 58 (61D of FIG. 4). On the other hand, the compressed audio data is sent from the seat terminal apparatus 4n to the seat terminal apparatus 4m, and is listened to as an audio by the headphone 7m of the self-seat 1m with remaining unchanged from before the changeover between the apparatuses for viewing and listening.

Although the seat terminal apparatus 4n or the compact video controller 5m send the compressed audio data to the seat terminal apparatus 4m, and the seat terminal apparatus 4m decodes the data in the internal audio decoder 45 for listening by the headphone 7m in the present preferred embodiment, the present invention is not limited to this, and it is acceptable to decode the data in the seat terminal apparatus 4n or the audio decoder 45 inside the compact video controller 5m or the audio decoder 55, thereafter, to send the decoded audio data to the seat terminal apparatus 4m, and to make the seat terminal apparatus 4m output the data as an audio by the headphone 7m.

Moreover, although the compact video controller 5m sends the compressed video data to the seat terminal apparatus 4n, and the seat terminal apparatus 4n decodes the data in the internal video decoder 44 and displays resulting data on the video display part 6n at the time of changeover of viewing and listening from the compact video controller 5m to the seat terminal apparatus 4n (first changeover operation) in the present preferred embodiment, the present invention is not limited to this, and it is acceptable to decode the data in the internal video decoder 54 of the compact video controller 5m, thereafter send the decoded video data to the seat terminal apparatus 4n, and make the seat terminal apparatus 4n display the data on the video display part 6n.

Moreover, although the compressed video data stored in the video and audio storage part 43 inside the compact video controller 5m is sent to the seat terminal apparatus 4n of the front seat 1n at the time of changeover of viewing and listening from the compact video controller 5m to the seat terminal apparatus 4n (first changeover operation) in the present preferred embodiment, it is acceptable to make the compact video controller 5m send the compressed video data to the seat terminal apparatus 4n with decoding the compressed video data and displaying the resulting data regardless of the selection of changeover. With this arrangement, by displaying the video that have already been sent out and stored at the time of changeover, more rapid video display becomes possible.

Moreover, although the compressed video data stored in the video and audio storage part 53 inside the compact video controller 5m is not delivered to the internal video decoder 54 at the time of changeover of viewing and listening from the compact video controller 5m to the seat terminal apparatus 4n (first changeover operation) in the present preferred embodiment, the present invention is not limited to this, and it is acceptable to continuously deliver the data to the video decoder 54 and continuously display the data on the compact video display part 58.

### Second Preferred Embodiment

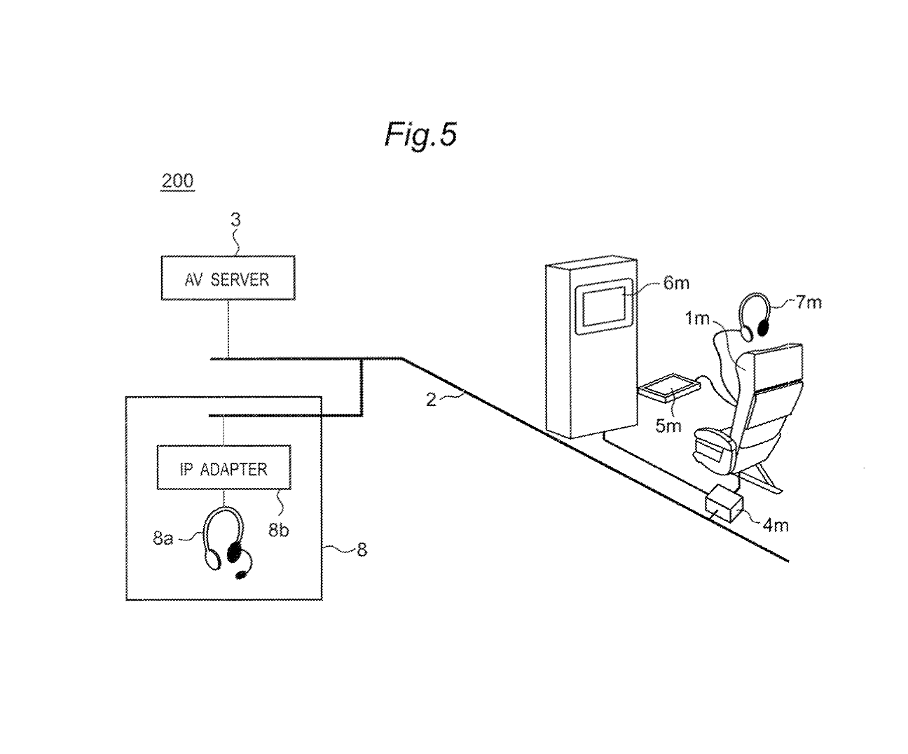

An AV contents viewing and listening system 200 according to the second preferred embodiment of the present invention is described below with reference to FIGS. 5 to 7.

FIG. 5 is a block diagram and an external perspective view showing an overall configuration of the AV contents viewing and listening system 200 of the second preferred embodiment of the present invention. Regarding the AV contents viewing and listening system 200 of FIG. 5, for example, an apparatus configuration relevant to a business class or a first class seat is shown. The configuration in appearance of the AV contents viewing and listening system 200 of the present preferred embodiment of FIG. 5 is characterized in that the video display part 6m connected to the seat terminal apparatus 4m of the self-seat 1m is placed on the front surface in comparison with the AV contents viewing and listening system 100 of the first preferred embodiment of FIG. 1. The other components are the same as those of the first preferred embodiment and therefore denoted by same reference numerals, and no description is provided for the components that have already been described.

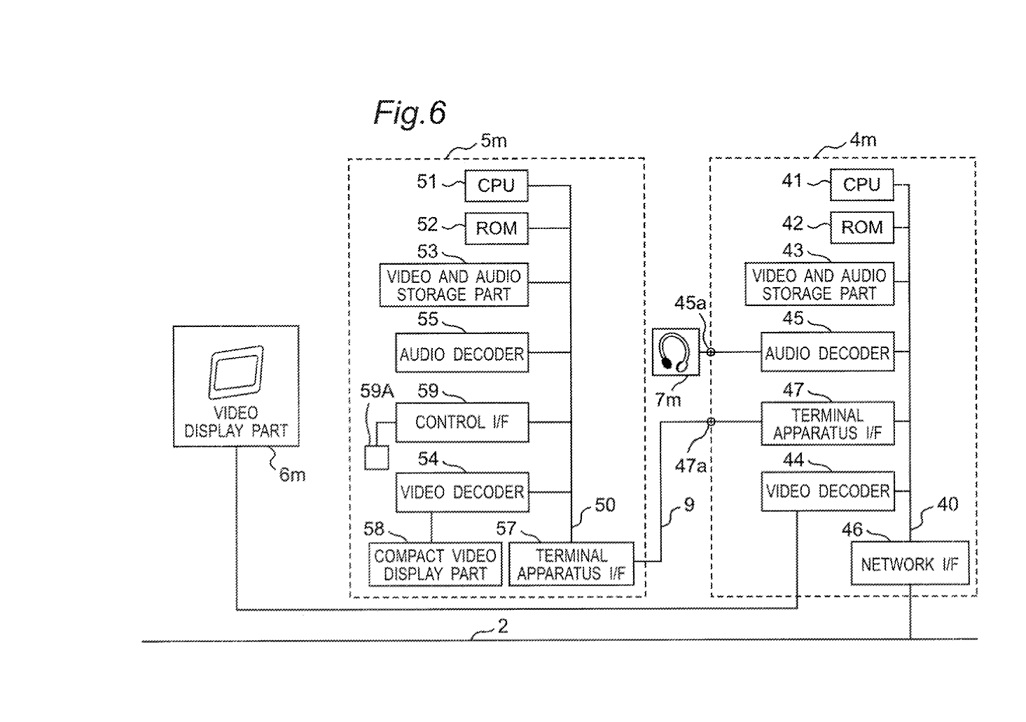

FIG. 6 is a block diagram showing detailed configurations of the seat terminal apparatuses 4m and 4n and the compact video controller 5m of FIG. 4. FIG. 6 shows the seat terminal apparatus 4m installed at the self-seat 1m, the compact video controller 5m, and the peripheral configuration, which have been described with reference to FIG. 5. In this case, the seat terminal apparatus 4m and the compact video controller 5m of the self-seat 1m are indicated by dotted line frames in FIG. 6. The components are the same as those of the first preferred embodiment and therefore denoted by same reference numerals, and no description is provided for the components that have already been described.

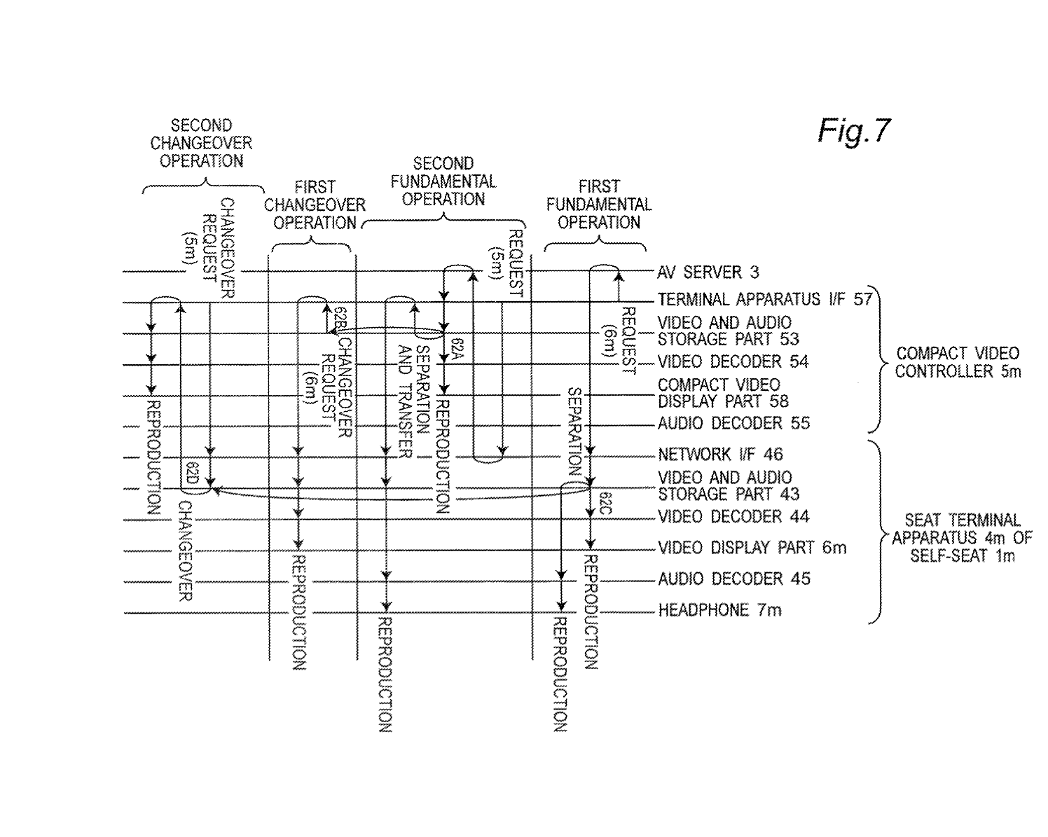

The operations of the AV contents viewing and listening system 200 configured as above are described below with reference to FIG. 7. FIG. 7 is a timing chart showing operations of the AV contents viewing and listening system 200 of FIG. 4. First of all, a case where the passenger in the self-seat 1m views and listens to the AV contents stored in the server 3 on the video display part 6m (first fundamental operation) is described.

In the first fundamental operation of FIG. 7, when the passenger selects viewing and listening of the AV contents that the passenger wants to view on the video display part 6m by operating the compact video controller 5m of the self-seat 1m, a request signal including the selected information is transmitted to the AV server 3 via the transmission path 2, the AV data configured to include the compressed video data and the compressed audio data including the AV contents are distributed from the AV server 3 to the seat terminal apparatus 4m of the self-seat 1m, and are temporarily stored in the internal video and audio storage part 43. When the passenger instructs reproduction or the like by operating the compact video controller 5m, for example, the CPU executes predetermined software (or by an exclusive hardware circuit) to separate the compressed video data and the compressed audio data from the AV data. Thereafter, the compressed video data stored in the video and audio storage part 43 is decoded in the video decoder 44 inside the seat terminal apparatus 4m of the self-seat 1m, and is displayed on the video display part 6m. On the other hand, the compressed audio data is decoded by the audio decoder 45 in the seat terminal apparatus 4m of the self-seat 1m, and thereafter, is listened to as an audio by the headphone 7m of the self-seat 1m.

Next, a case where the passenger views and listens to the AV contents stored in the AV server 3 on the compact video display part 58 of the compact video controller 5m (second fundamental operation) is similar to the operation in the first preferred embodiment, and the case is described with reference to FIG. 7.

Further, a case where the passenger performs changeover from viewing and listening on the compact video controller 5m to viewing and listening on the seat terminal apparatus (first changeover operation) is described.

When the passenger selects viewing and listening by the video display part 6m by operating the compact video controller 5m of the self-seat 1m in the state of viewing and listening of AV contents with the compact video display part 58 of the compact video controller 5m of the self-seat 1m (62A of FIG. 7) in the first changeover operation of FIG. 7, the compressed video data stored in the video and audio storage part 53 inside the compact video controller 5m is not delivered to the internal video decoder 54 but sent to the seat terminal apparatus 4m of the self-seat 1m via the network I/F 57 and the terminal apparatus transmission path 9 (62B of FIG. 7). At the seat terminal apparatus 4m of the self-seat 1m, the loaded compressed video data is decoded by the video decoder 44 and displayed on the video display part 6m. On the other hand, the compressed audio data is sent from the compact video controller 5m of the self-seat 1m to the seat terminal apparatus 4m, and is listened to as an audio by the headphone 7m of the self-seat 1m with remaining unchanged from before the changeover between the terminal apparatuses for viewing and listening.

In this case, since the video display is delayed by the time of transmission of the compressed video data via the terminal apparatus transmission path 9, synchronization with the video and audio of the seat terminal apparatus 4m is achieved by delaying the read timing of the compressed video data from the video and audio storage part 53 of the compact video controller 5m regardless of the changeover of viewing and listening. The method of achieving the synchronization with the video of the present invention is not limited to this, and it is acceptable to add a delay circuit for simultaneously reading the video and audio compressed data and delaying only the audio by the time. Further, more accurate synchronization becomes possible if reproduction is made by inserting a time stamp into the video and audio data, and the amount of delay is controlled on the basis of the time stamp.

When the passenger instructs stop or temporary stop and instructs again reproduction or the like upon operating the compact video controller 5m after the first changeover operation, the AV data including the AV contents that have been viewed and listened to is distributed from the AV server 3 to the seat terminal apparatus 4m of the self-seat 1m and is temporarily stored in the internal video and audio storage part 43, and changeover to viewing and listening on the video display part 6m is subsequently effected.

As described above, in the present preferred embodiment, the compact video controller 5m is provided, and the compact video controller 5m receives the AV contents of the AV server 3 and displays the contents on the compact video display part 58 (62A of FIG. 7). The audio is sent to the seat terminal apparatus 4m of the self-seat 1m and listened to by the headphone 7m of the self-seat 1m. When changeover is effected to viewing and listening on the video display part 6m by the video controller 5m, the compact video controller 5m sends the video to the seat terminal apparatus 4m of the self-seat 1m (62B of FIG. 7) and displays the video on the video display part 6m of the self-seat 1m, and the audio is continuously listened to by the headphone 7m of the self-seat 1m.

With the above configuration, according to the present preferred embodiment, changeover between the apparatuses for viewing and listening can be effected without giving any unpleasant sensation due to interruption or fluctuation to the passenger.

Although the changeover of viewing and listening to the seat terminal apparatus 4m is effected from the compact video controller 5m (first changeover operation) in the present preferred embodiment, the present invention is not limited to this, and it is acceptable to effect changeover of viewing and listening from the seat terminal apparatus 4m to the compact video controller 5m (second changeover operation). In the case, when the passenger selects viewing and listening by the compact video display part 58 of the compact video controller 5m by operating the compact video controller 5m of the self-seat 1m in the state of viewing and listening of AV contents with the video display part 6m (62C of FIG. 7) in the changeover operation of FIG. 7 as described above, the seat terminal apparatus 4m sends the compressed video data to the compact video controller 5m (62D of FIG. 7), and the compact video controller 5m decodes the data in the internal video decoder 44 and displays the decoded data on the compact video display part 58. On the other hand, the compressed audio data is continuously listened to as an audio by the headphone 7m of the self-seat 1m with remaining unchanged from before the changeover between the terminal apparatuses for viewing and listening.

Moreover, it is acceptable to make the compact video controller 5m decode the compressed audio data in the internal audio decoder 45 and thereafter send the resulting data to the seat terminal apparatus 4m, and make the seat terminal apparatus 4m output this as an audio by the headphone 7m in the present preferred embodiment in a manner similar to that of the first preferred embodiment.

Moreover, although the compact video controller 5m sends the compressed video data to the seat terminal apparatus 4m, and the seat terminal apparatus 4m decodes the data in the internal video decoder 44 and thereafter displays the resulting data on the video display part 6m at the time of changeover of viewing and listening from the compact video display part 58 of the compact video controller 5m to the video display part 6m (first changeover operation) in the present preferred embodiment, the present invention is not limited to this, and it is acceptable to decode the data in the video decoder 44 inside the compact video controller 5m, send the decoded video data to the seat terminal apparatus 4m, and make the seat terminal apparatus 4m display this on the video display part 6m.

Moreover, although the compressed video data stored in the video and audio storage part 43 in the compact video controller 5m is sent to the seat terminal apparatus 4m of the self-seat 1m at the time of changeover of viewing and listening from the compact video display part 58 of the compact video controller 5m to the video display part 6m (first changeover operation) in the present preferred embodiment, the present invention is not limited to this, and it is acceptable to make the compact video controller 5m send the compressed video data to the seat terminal apparatus 4m with decoding the compressed video data and displaying the resulting data regardless of the selection of changeover. With this arrangement, by displaying the video that have already been sent out and stored at the time of changeover, more rapid video display becomes possible.

Moreover, although the compressed video data stored in the video and audio storage part 53 inside the compact video controller 5m is not delivered to the internal video decoder 54 at the time of changeover of viewing and listening from the compact video controller 5m to the seat terminal apparatus 4m (first changeover operation) in the present preferred embodiment, the present invention is not limited to this, and it is acceptable to continuously deliver the data to the video decoder 54 and continuously display the data on the compact video display part 58.

### Third Preferred Embodiment

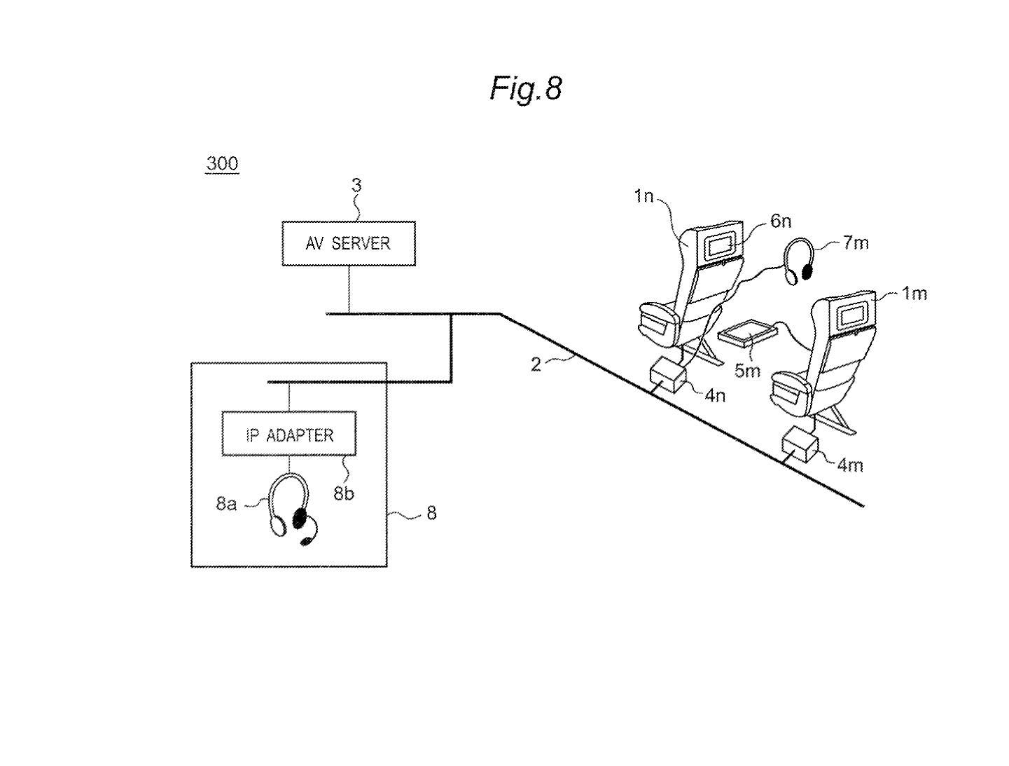

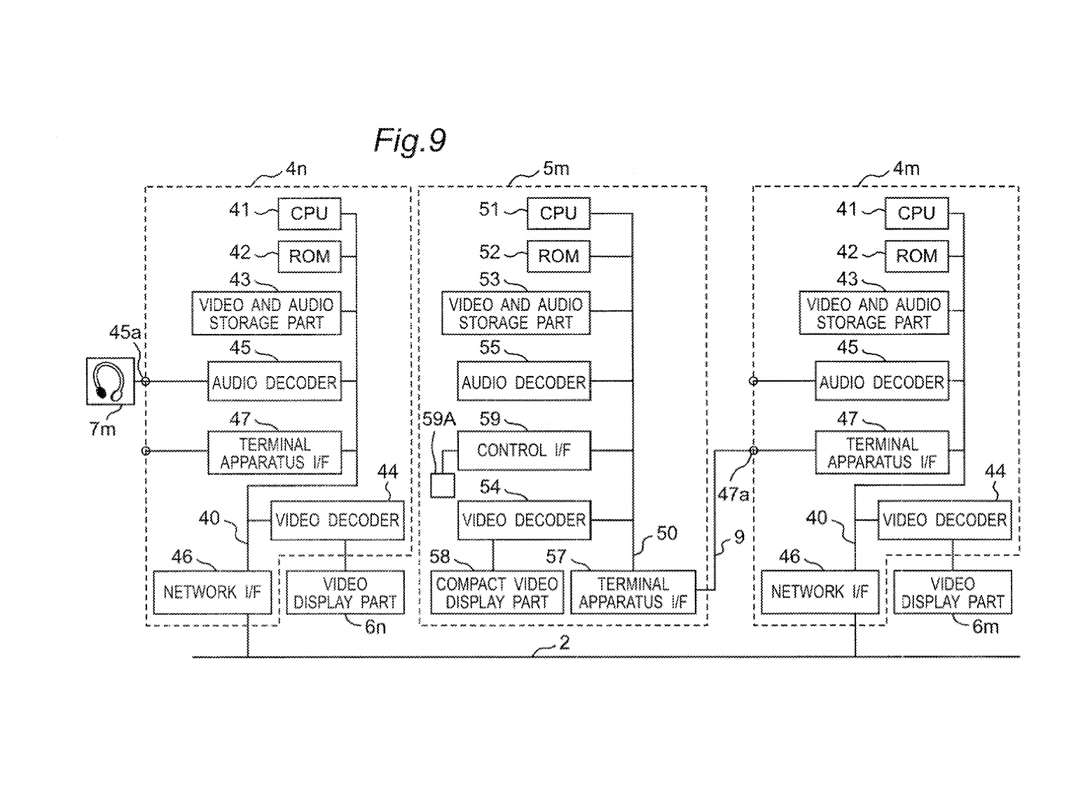

FIG. 8 is a block diagram and an external perspective view showing an overall configuration of an AV contents viewing and listening system 300 according to the third preferred embodiment of the present invention. FIG. 9 is a block diagram showing detailed configurations of the seat terminal apparatuses 4m and 4n and the compact video controller 5m of FIG. 8. In comparison with the AV contents viewing and listening system 100 of the first preferred embodiment of FIG. 1, the AV contents viewing and listening system 300 of the third preferred embodiment of FIGS. 8 and 9 is characterized in that:

(1) the headphone 7m is connected to the seat terminal apparatus 4n of the front seat 1n instead of being connected to the seat terminal apparatus 4m of the self-seat 1m, and

(2) in the case of viewing and listening by using the video display part 6n of the front surface, the seat terminal apparatus 4n of the front seat in processes the compressed video data and the compressed audio data.

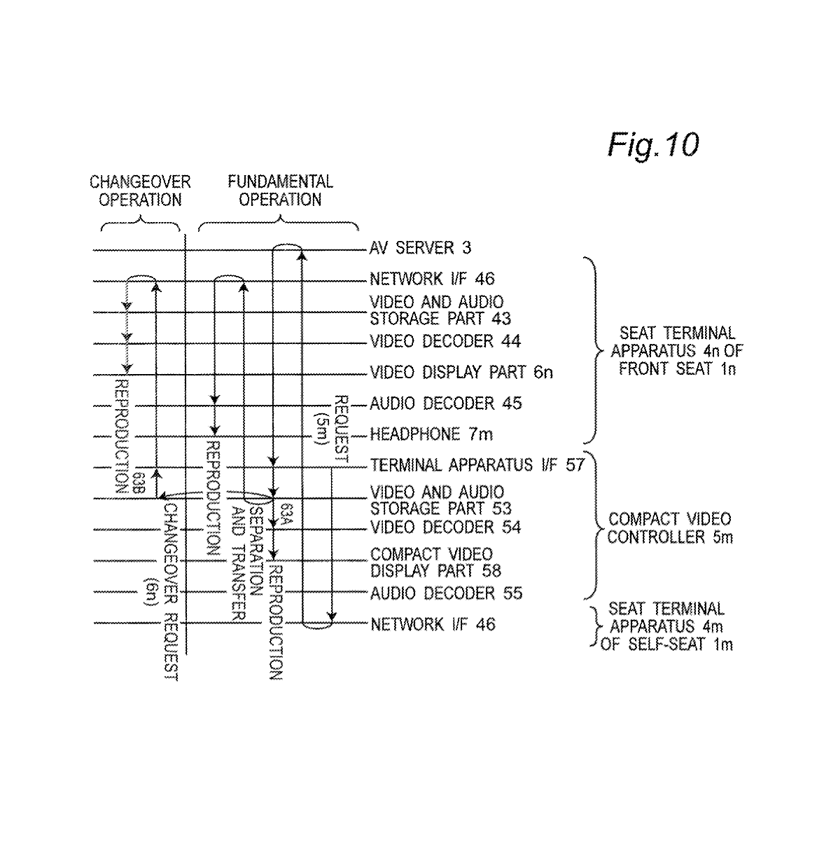

FIG. 10 is a timing chart showing operations of the AV contents viewing and listening system 300 of FIG. 8. The fundamental operation and the changeover operation of FIG. 10 (changeover from 63A to 63B of FIG. 10) corresponds to the second fundamental operation and the first changeover operation of FIG. 7, and these operations are similar to the operations of the second preferred embodiment except for only the seat terminal apparatus 4m of the self-seat 1m moved to the front seat 1n.

### Fourth Preferred Embodiment

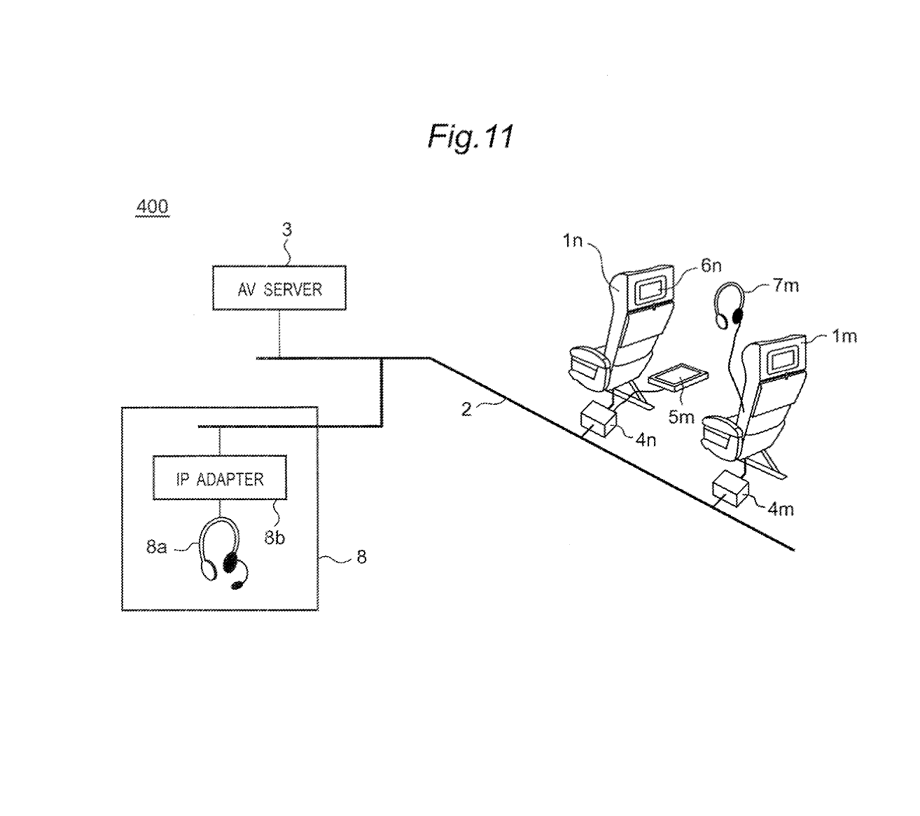

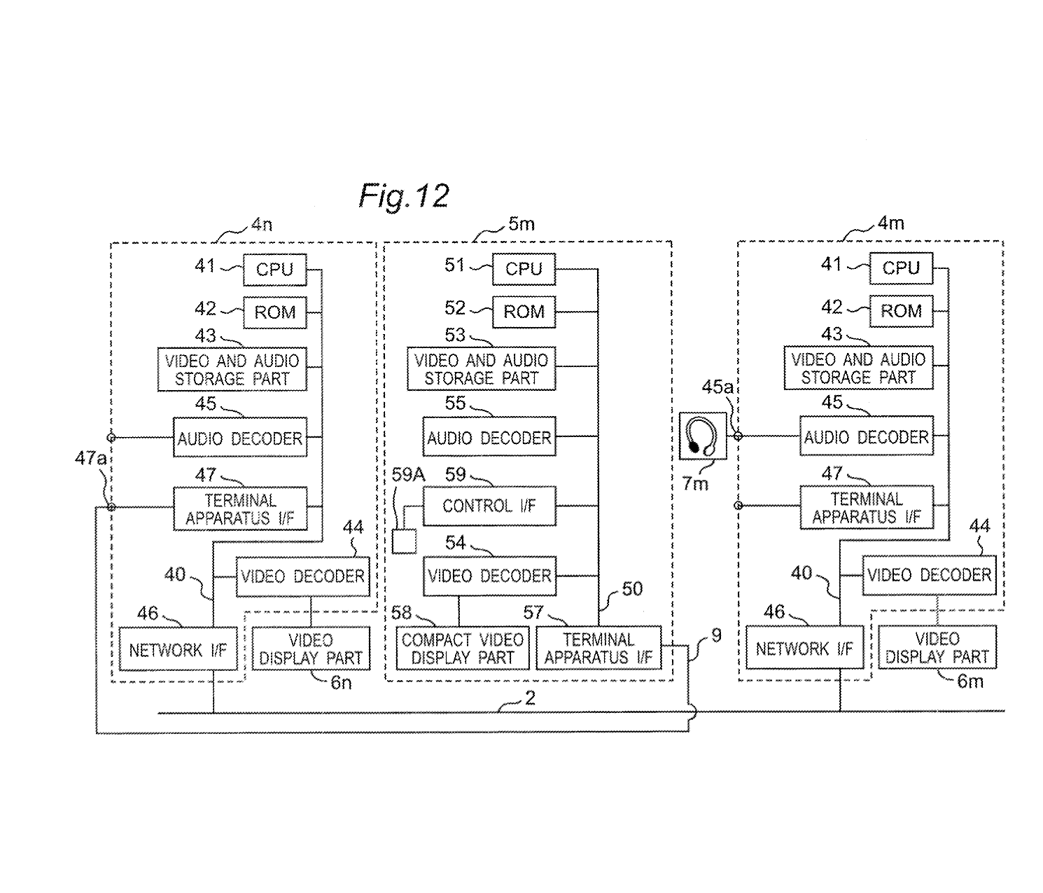

FIG. 11 is a block diagram and an external perspective view showing an overall configuration of an AV contents viewing and listening system 400 according to the fourth preferred embodiment of the present invention. FIG. 12 is a block diagram showing detailed configurations of the seat terminal apparatuses 4m and 4n and the compact video controller 5m of FIG. 11. In comparison with the AV contents viewing and listening system 100 of the first preferred embodiment of FIG. 1, the AV contents viewing and listening system 400 of the fourth preferred embodiment of FIGS. 11 and 12 is characterized in that:

(1) the compact video controller 5m is connected to the seat terminal apparatus 4n of the front seat 1n instead of being connected to the seat terminal apparatus 4m of the self-seat 1m, and

(2) in the case of viewing and listening by using the video display part 6n of the front surface, the seat terminal apparatus 4n of the front seat 1n processes the compressed video data in a manner similar to that of the first preferred embodiment.

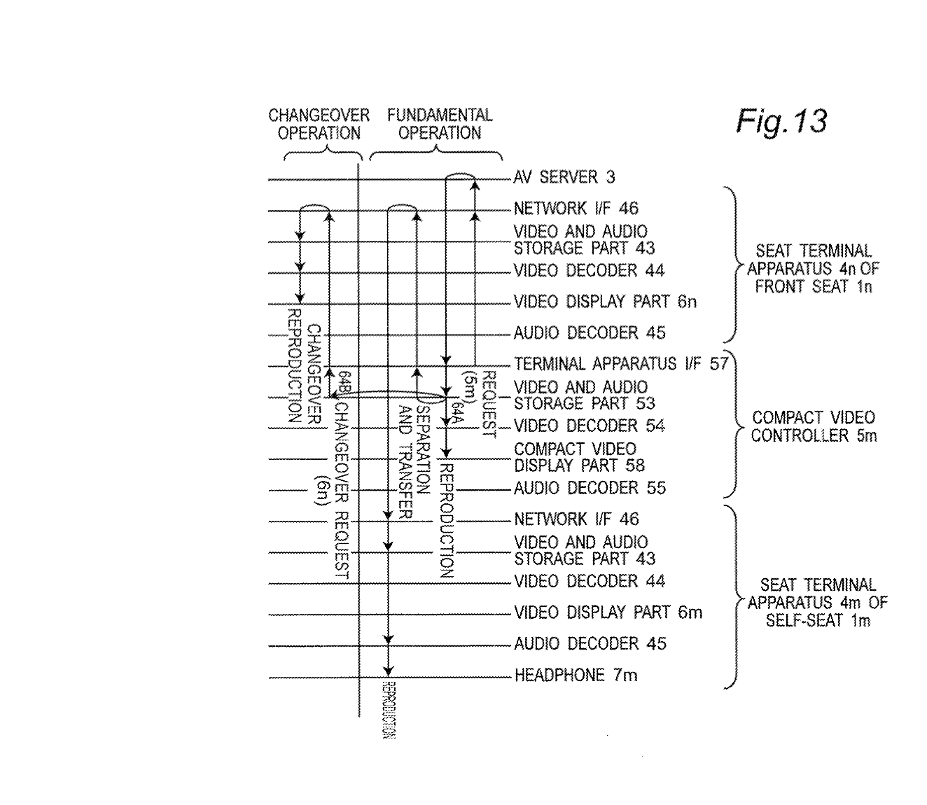

FIG. 13 is a timing chart showing operations of the AV contents viewing and listening system 400 of FIG. 11. The fundamental operation and the changeover operation of FIG. 13 (changeover from 64A to 64B of FIG. 13) corresponds to the second fundamental operation and the first changeover operation of FIG. 4, and these operations are similar to the operations of the first preferred embodiment.

### Fifth Preferred Embodiment

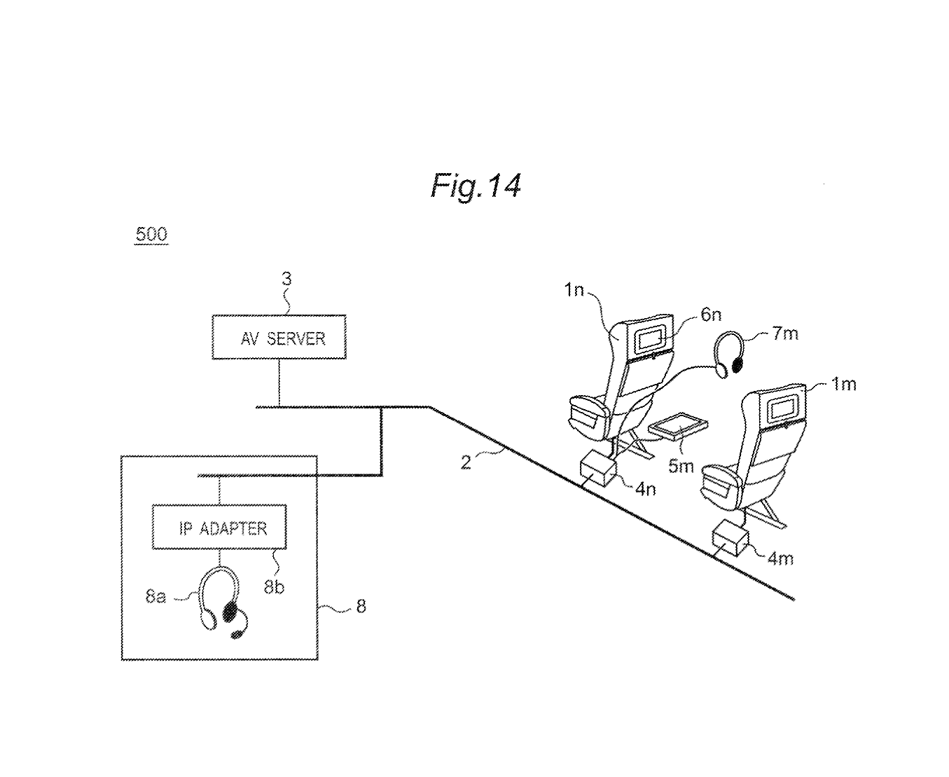

FIG. 14 is a block diagram and an external perspective view showing an overall configuration of an AV contents viewing and listening system 500 according to the fifth preferred embodiment of the present invention. In comparison with the AV contents viewing and listening system 100 of the first preferred embodiment of FIG. 1, the AV contents viewing and listening system 500 of the fifth preferred embodiment of FIG. 14 is characterized in that the headphone 7m and the compact video controller 5m are connected to the seat terminal apparatus 4n of the front seat 1n instead of being connected to the seat terminal apparatus 4m of the self-seat 1m. With the above arrangement, the video display part 6n, the compact video controller 5m and the headphone 7m are all connected to the seat terminal apparatus 4n of the front seat 1n and the processing of the compressed video data and the compressed audio data is executed by one apparatus, and therefore, the fundamental operation and the changeover operation are similar to those of the second preferred embodiment.

### Sixth Preferred Embodiment

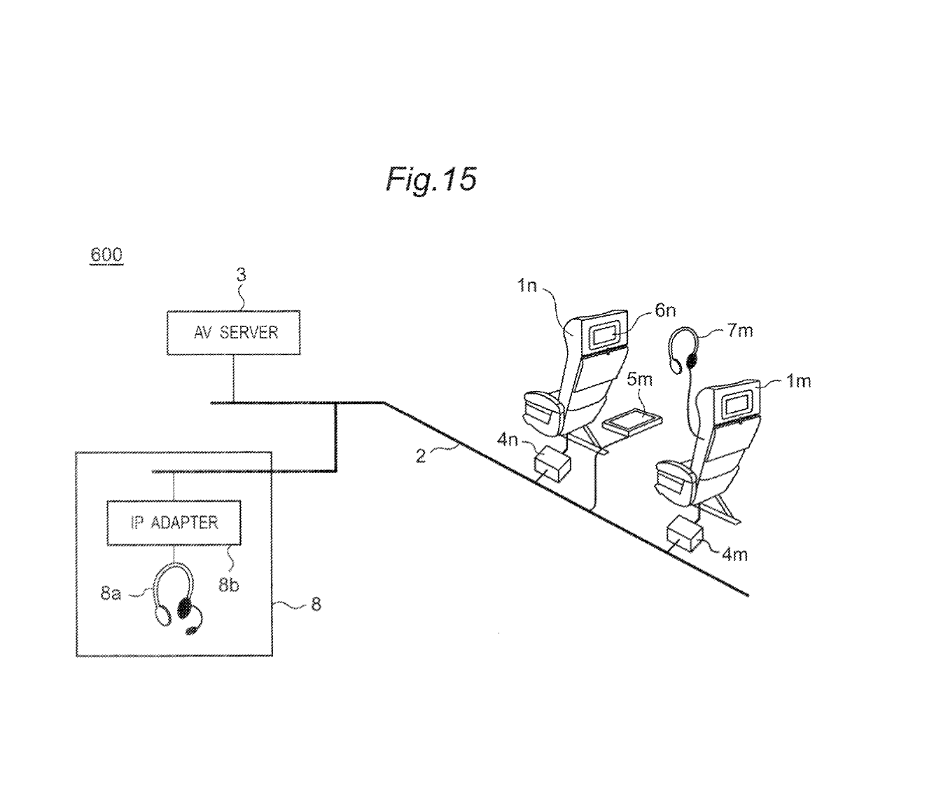

FIG. 15 is a block diagram and an external perspective view showing an overall configuration of an AV contents viewing and listening system 600 according to the sixth preferred embodiment of the present invention. In comparison with the AV contents viewing and listening system 100 of the first preferred embodiment of FIG. 1, the AV contents viewing and listening system 600 of the sixth preferred embodiment of FIG. 15 is characterized in that:

(1) the compact video controller 5m is connected directly to the transmission path 2 instead of being connected to the seat terminal apparatus 4m of the self-seat 1m; and

(2) the compact video controller 5m has a network I/F 46 in place of the terminal apparatus I/F 57 in accordance with the item (1).

With the above arrangement, the compact video controller 5m transfers the compressed audio data to the seat terminal apparatus 4m of the self-seat 1m, and transfers the compressed video data to the seat terminal apparatus 4n of the front seat in. Therefore, the fundamental operation corresponds to the second fundamental operation of FIG. 4 of the first preferred embodiment.

### Seventh Preferred Embodiment

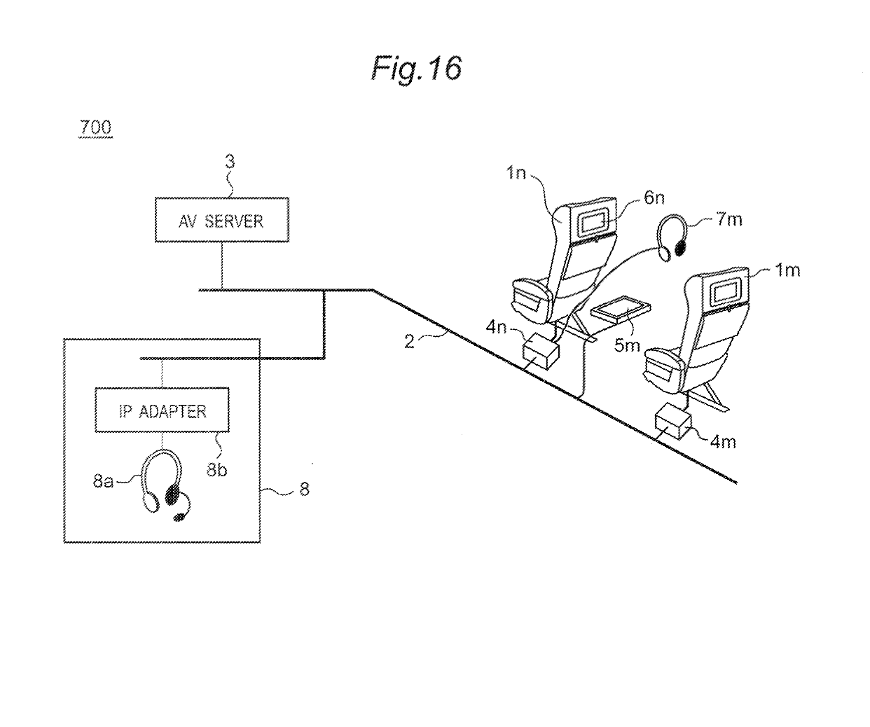

FIG. 16 is a block diagram and an external perspective view showing an overall configuration of an AV contents viewing and listening system 700 according to the seventh preferred embodiment of the present invention. In comparison with the AV contents viewing and listening system 100 of the first preferred embodiment of FIG. 1, the AV contents viewing and listening system 700 of the seventh preferred embodiment of FIG. 16 is characterized in that:

(1) the compact video controller 5m is connected directly to the transmission path 2 instead of being connected to the seat terminal apparatus 4m of the self-seat 1m;

(2) the compact video controller 5m has a network I/F 46 in place of the terminal apparatus I/F 57 in accordance with the item (1); and

(3) the headphone 7m is connected to the seat terminal apparatus 4n of the front seat 1n.

With the above arrangement, the compact video controller 5m transfers the compressed audio data and the compressed video data to the seat terminal apparatus 4n of the front seat 1n. Therefore, the fundamental operation corresponds to the fundamental operation and the changeover operation of FIG. 10 of the third preferred embodiment.

### Modified Preferred Embodiment

Although the headphones 7m and 7n are used in each of the aforementioned preferred embodiments, the present invention is not limited to this, and it is acceptable to use a loudspeaker with an amplifier that is provided at the self-seat or the front seat and connected to the audios decoders 45 and 55 or a loudspeaker connected via an amplifier from the audio decoders 45 and 55 in place of the headphones 7m and 7n.

As described in detail above, the AV contents viewing and listening systems of the present invention are useful for AV contents viewing and listening systems that are mounted at each seat installed in the cabins of passenger carriers such as aircraft and that is provided for viewing and listening AV software of movies, musics and the like and game software, and are also able to be utilized for public transport systems of vehicles of buses, railway trains and the like, ocean vessels of ferry boats, passenger boats and the like.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An AV contents viewing and listening system comprising:
a seat terminal apparatus operatively connected to an AV server that stores AV contents to be distributed including video data and audio data via a transmission path, the seat terminal apparatus receiving and outputting at least the audio data;
a compact terminal apparatus connected to the seat terminal apparatus via a terminal apparatus transmission path, the compact terminal apparatus receiving and displaying at least the video data; and
a display terminal apparatus configured to receive the video data from the compact terminal apparatus and display the data,
wherein the video data is displayed one of by selective changeover between the compact terminal apparatus and the display terminal apparatus, and by simultaneously display on both of the compact terminal apparatus and the display terminal apparatus.

2. The AV contents viewing and listening system as claimed in claim 1,
wherein the seat terminal apparatus is installed at each of a plurality of seats arranged frontward and hindward, and the seat terminal apparatus installed at a self-seat is a seat terminal apparatus that receives at least the audio data and outputs the data, and
wherein the seat terminal apparatus installed on a back part of the front seat of the self-seat is a display terminal apparatus that is connected to a video display part, receives the video data from the compact terminal apparatus, and displays the data.

3. The AV contents viewing and listening system as claimed in claim 1,
wherein the compact terminal apparatus comprises a compact video display part, and a video and audio storage part that stores the AV contents distributed from the AV server,
wherein the AV contents read from the video and audio storage part are separated into video data and audio data, and
wherein the separated video data is displayed on the compact video display part; otherwise the separated video data is transmitted via the terminal apparatus transmission path of the seat terminal apparatus of the self-seat, and then is displayed on the video display part connected to the seat terminal apparatus of the self-seat.

4. The AV contents viewing and listening system as claimed in claim 2,
wherein the compact terminal apparatus comprises a compact video display part, and a video and audio storage part that stores the AV contents distributed from the AV server,
wherein the AV contents read from the video and audio storage part are separated into video data and audio data, and
wherein the separated video data is displayed on the compact video display part; otherwise the separated video data is transmitted via the terminal apparatus transmission path of the seat terminal apparatus of the self-seat, and then is displayed on the video display part connected to the seat terminal apparatus of the front seat.

5. The AV contents viewing and listening system as claimed in claim 1,
wherein the seat terminal apparatus comprises a video and audio storage part that stores the AV contents distributed from the AV server,
wherein the AV contents read from the video and audio storage part are separated into video data and audio data,
wherein the separated audio data is outputted from the seat terminal apparatus of the self-seat, and
wherein the separated video data is displayed on the video display part connected to the seat terminal apparatus of the self-seat; otherwise the separated video data is transmitted via the terminal apparatus transmission path of the seat terminal apparatus of the self-seat, and then is displayed on the compact video display part of the compact terminal apparatus.

6. The AV contents viewing and listening system as claimed in claim 2,
wherein the seat terminal apparatus comprises a video and audio storage part that stores the AV contents distributed from the AV server,
wherein the AV contents read from the video and audio storage part are separated into video data and audio data,
wherein the separated audio data is outputted from the seat terminal apparatus of the self-seat, and
wherein the separated video data is transmitted via the terminal apparatus transmission path of the seat terminal apparatus of the self-seat, and then is displayed on the compact video display part of the compact terminal apparatus;
otherwise the separated video data is displayed on the video display part connected to the seat terminal apparatus of the front seat.

7. The AV contents viewing and listening system as claimed in claim 1,
wherein the compact terminal apparatus is a compact video controller provided for operations of selecting predetermined AV contents and instructing the AV server to distribute the AV contents.

8. The AV contents viewing and listening system as claimed in claim 1,
wherein the AV contents distributed from the AV server is encoded compressed data, and
wherein the AV contents is stored in a video and audio storage part of one of the compact terminal apparatus and the seat terminal apparatus, and the AV contents are decoded and outputted by a decoder provided in one of the compact terminal apparatus and the seat terminal apparatus.

9. The AV contents viewing and listening system as claimed in claim 1,
wherein the audio data is outputted by a headphone connected to the seat terminal apparatus of the self-seat.

10. The AV contents viewing and listening system as claimed in claim 1,
wherein a display timing of the video data and an output timing of the audio data are adjusted so that one of the video displayed on the compact video display part and the video displayed on the video display part is synchronized with an audio outputted by the headphone.

11. The AV contents viewing and listening system as claimed in claim 1,
wherein the AV contents viewing and listening system is mounted in an aircraft.
